(19) United States
(12) Patent Application Publication
(10) Pub. No.: US 2020/0217407 A1
(43) Pub. Date: Jul. 9, 2020

(54) GEAR

(71) Applicant: Miba Sinter Austria GmbH, Laakirchen (AT)

(72) Inventors: Wolfgang SCHIMPL, Scharnstein (AT); Philipp PICHLER, Thalheim bei Wels (AT); Christian DUMANSKI, Plesching - Steyregg (AT); Martin KARLSBERGER, Eberstalzell (AT)

(73) Assignee: Miba Sinter Austria GmbH, Laakirchen (AT)

(21) Appl. No.: 16/716,876

(22) Filed: Dec. 17, 2019

(30) Foreign Application Priority Data
Jan. 4, 2019 (AT) A 50003/2019

(51) Int. Cl. F16H 55/17; F16F 15/26

(52) U.S. Cl. CPC F16H 55/17; F16F 15/264

(57) ABSTRACT

A gear includes a first, radially inner ring element, a second, radially outer ring element and a connecting element, wherein the second, radially outer ring element includes a toothing, wherein further the connecting element is arranged in the radial direction between the first, radially inner ring element and the second, radially outer ring element and is connected to the first, radially inner ring element and the second, radially outer ring element, and wherein the connecting element is made at least partly from a rubbery-elastic material, and wherein a deviation of the coaxiality of the outer diameter of the first, radially inner ring element to the inner diameter of the second, radially outer ring element amounts to a maximum of 0.8 mm and/or the toothing of the radially outer ring element is formed with teeth having different tooth thicknesses.

### CROSS REFERENCE TO RELATED APPLICATIONS

Applicant claims priority under 35 U.S.C. § 119 of Austrian Application No. A 50003/2019 filed on Jan. 4, 2019, the disclosure of which is incorporated by reference.

### BACKGROUND OF THE INVENTION

### 1. Field of the Invention

The invention relates to a gear comprising a first, radially inner ring element, a second, radially outer ring element and a connecting element, wherein the second, radially outer ring element comprises a toothing, wherein further the connecting element is arranged in the radial direction between the first, radially inner ring element and the second, radially outer ring element and is connected to the first, radially inner ring element and the second, radially outer ring element, and wherein the connecting element is made at least partly from a rubbery-elastic material.

The invention further relates to a gear drive comprising a crankshaft with a first gear, which is arranged in meshing engagement with a second gear, wherein the second gear is arranged on a mass balance shaft.

The invention also relates to a method for producing a gear comprising the steps: provision of a first, radially inner ring element; provision of a second, radially outer ring element; arrangement of the first, radially inner ring element at a distance from the second, radially outer ring element forming an intermediate space; production of a connecting element between the first, radially inner ring element and the second, radially outer ring element by provision of a vulcanizable or polymerizable mass in the intermediate space.

Moreover, the invention relates to a device for producing a gear comprising a first, radially inner ring element, a second, radially outer ring element and a connecting element, wherein the connecting element is arranged in the radial direction between the first, radially inner ring element and the second, radially outer ring element and is connected to the first, radially inner ring element and the second, radially outer ring element, and wherein the connecting element is made at least partly from a rubbery-elastic material, with a mold cavity for receiving the first, radially inner ring element and the second, radially outer ring element at a distance from the first, radially inner ring element forming an intermediate space, and with at least one feed unit for a vulcanizable or polymerizable mass for producing the connecting element.

### 2. Description of the Related Art

As is known, balance shafts are used in combustion engines in order to reduce vibrations caused by free inertia forces and inertia torques. The balance shaft is usually driven by the crankshaft and for this purpose the latter is in operative connection therewith via a gear. In order to reduce the development of noise from the intermeshing toothings between the balance shaft and the crankshaft and to capture the vibrations divided gears are known from the prior art, wherein the two parts are connected by a rubber-elastic connecting element.

Such divided gears are generally known for damping the vibration and noise of machine components. For example, DE 71 35 220 U1 describes a vibration-damped gear wheel with an inner part which has an annular groove on its outer casing surface, an annular outer part arranged concentric to and at distance from the inner part, which outer part on its inner casing surface also has an annular groove, which together with the annular groove arranged on the inner part forms an annular space, into which a rubber-elastic profile ring connecting the inner part and outer part in a non-rotatable manner is inserted, the undeformed radial extension of which is greater than that of the annular space formed between the inner and outer part, wherein at least one of the two annular grooves comprises extensions preferably arranged with a regular pitch.

A similar gear is known from U.S. Pat. No. 2,307,129 A, but with a differently shaped elastic connecting element, which has a rectangular cross-section.

Instead of a simple profile ring the elastic connecting element can also be made from a laminate, as known for example from U.S. Pat. No. 4,674,351 A.

From EP 2 623 820 A, a gear is known which comprises an inner part, which is connected to the source of the vibrations, a connecting element and a gear rim, wherein the connecting element is designed so that the caused vibrations are reduced. The connecting element can be made from an elastic synthetic material, such as RTV-plastic, silicone or a resin system.

The rubber-elastic connecting elements are also used for centering the parts of the divided gear connected therewith, as known from DE 31 53 109 C2. This publication describes a noise-dampened machine element, consisting of two parts connected together in a form-fitting manner by a damping element, in particular parts arranged coaxially to one another, in particular the hub and running rim of a wheel, wherein the damping element connecting the two parts and bearing on oblique walls is made from a pourable material, which passes from the pourable state by shrinking to the elastic state, wherein the parts connected by the damping element comprise mounting spaces arranged evenly about the common axis, and open towards the joint for the material on the oblique walls, wherein during the shrinkage the material forms a tension rod and is drawn in a centering manner against said wall as in a clamping cone or clamping wedge.

DE 602 05 710 T2 describes a balance system for a combustion engine, comprising a drive shaft which supports a first pinion which is driven by a gear ring of the crankshaft of the engine, and a second pinion, which drives a driven shaft by a third pinion which is firmly secured onto the latter, wherein the first pinion contains a ring made of flexible material, such as e.g. rubber, which is inserted between two rings made of steel, which are each secured to the drive shaft and the inside of the pinion. In this document it has already been recognized that the flexible ring absorbs the oscillations transmitted by the crankshaft and is thus subjected to increased load. Therefore, in a special embodiment it is proposed that the ring has the form of a daisy or an elliptical form, in order to introduce a non-linear rigidity into the system so that resonance phenomena are avoided which can cause a tear in the system, with a disconnection of the vibrations which come from the crankshaft.

EP 1 245 869 A2 describes a gear comprising an inner part and an annular outer part provided with teeth externally around its circumference, wherein the outer part encompasses the inner part with a radial clearance and wherein at least one spring body made of an elastomer material is arranged in the gap formed by the clearance. The spring body can be formed to be essentially wave-shaped, closed in the circumferential direction.

FR 2 730 022 A1 describes a mechanism consisting of a drive pinion that is rotated by a motor and a driven gear that meshes with the pinion. The gear comprises a shock absorber located between its hub and the toothing.

AT 514 590 B1 describes a gear comprising a first, radially inner ring element, a second, radially outer ring element and a connecting element, wherein the second, radially outer ring element comprises a toothing, wherein further the connecting element is arranged in the radial direction between the first, radially inner ring element and the second, radially outer ring element and is connected to the first, radially inner ring element and the second, radially outer ring element, and wherein the connecting element is made at least partly from a rubbery-elastic material.

Particularly with the use of such gears in balance shafts, said gears are subjected to an increased mechanical load because of the unbalance, which means that the axial spacing of the inner ring element relative to the outer ring changes. In this way the elastic connecting element arranged between two said ring elements is subjected to a continually changing tensile and compressive load. As a result, the connecting element may get torn off.

### SUMMARY OF THE INVENTION

It is the object of the present invention to reduce the risk of tearing off of the elastic connecting element from one of the two ring elements in such a gear.

In the initially mentioned gear, the object of the invention is achieved in that a deviation of the coaxiality of the outer diameter of the first, radially inner ring element to the inner diameter of the second, radially outer ring element amounts to a maximum of 0.8 mm and/or the toothing of the radially outer ring element is formed with teeth having different tooth thicknesses.

The invention is further achieved by the initially mentioned gear drive in which the second gear is designed according to the invention.

The object of the invention is also achieved by means of the initially mentioned method in which it is provided for that the first, radially inner ring element and the second, radially outer ring element are each formed with at least one recess in an end face and the first, radially inner ring element and the second, radially outer ring element are centered by means of a centering tool which engages in the recesses before the vulcanizable or polymerizable mass is filled into the intermediate space.

Moreover, the object of the invention is achieved by means of the initially mentioned device for producing the gear, said device comprising a centering unit, which respectively engages in at least one recess in an end face of the first, radially inner ring element and in an end face of the second, radially outer ring element for centering the first, radially inner ring element and the second, radially outer ring element with respect to one another.

The advantage of this is that by the better centering of the two ring elements with respect to one another, the load of the connecting element during operation of the gear can be reduced. Centering of the two ring elements can be established relatively easily and with high precision in the production of the gear by means of the mentioned device. Since the two ring elements are preferably made from a sintered material, the recesses for the engagement of the centering tool can already be taken into account during the production of the green bodies for the ring elements, which also entails little or no additional effort. The formation of the toothing with teeth of different tooth thicknesses also serves to reduce the mechanical load of the connecting element by improving the contact pattern of the toothing. As a consequence of the lower mechanical load of the connecting element, thus the risk of the connecting element being torn off one of the two ring elements can also be reduced.

According to a preferred embodiment variant of the invention, it can be provided for that both the first, radially inner ring element and the second, radially outer ring element are at least sectionally formed with a groove in an end face in order to improve the advantages described above of easy centering of the ring elements with the device, since the grooves allow a more precise centering as compared to other recesses.

According to a further embodiment variant of the invention it can be provided for that the connecting element is formed to be planar on an outer surface or solely with at least one elevation and without recesses. By avoiding recesses in the outer, radial surface, an improvement of the mechanical load capacity of the connecting element and hence a further reduction of the risk of the connecting element being torn off one of the ring elements can be achieved.

According to another embodiment variant of the invention, it can be provided for that the first, radially inner ring element is provided with at least one first curvature in the connection area between the first, radially inner ring element and the connecting element. By means of this curvature, a notch effect of the edge of the inner ring element in the connection area with the connecting element can be avoided and hence the resistance of the connection of the connecting element to the first, radially inner ring element can be improved.

In this regard, it is advantageous if according to embodiment variants the curved area in the axial direction of the first, radially inner ring element has a width selected from a range of 0.5% to 50% of the radial thickness of the connecting element between the first, radially inner ring element and the second, radially outer ring element and/or if the radius of the first curvature across the extent in the axial direction differs and/or if the first curvature has several radii, preferably between two and five different radii, with a size increasing as seen from the outside towards the inside. Hence, the area with the highest load of the connecting element can be moved to an area which is less critical for the risk of the connecting element being torn off a ring element. This area can, for example, be displaced with at least one of these measures from the curved edge on the end face in the axial direction towards the central area of the lateral surface of the first, radially inner ring element.

According to other embodiment variants of the invention, it can be provided for that the second, radially outer ring element is also provided with at least one second curvature in the connection area between the second, radially outer ring element and the connecting element, wherein the second curvature is smaller than the first curvature or that the second, radially outer ring element is designed to be sharp-edged in the connection area between the second, radially outer ring element and the connecting element. Surprisingly, it has been noticed that the influence of the edge of the second, radially outer ring element onto the mechanical load capacity of the connecting element, in particular in the connection areas with the ring elements, is significantly lower than that of the edges of the first, radially inner ring element. Thus, in these embodiment variants the processing effort for the production of the gear can be reduced also with an overall improved mechanical load capacity of the connecting element.

According to a further embodiment variant of the invention, it can be provided for that the first radius of the first curvature of the first, radially inner ring element in the connection area between the first, radially inner ring element and the connecting element amounts to at least 0.1 mm, that further the connecting element in the area between the first, radially inner ring element and the second, radially outer ring element has a wall thickness in the radial direction of at least 0.5 mm, in particular selected from a range of 0.5 mm to 10 mm, preferably selected from a range between 3 mm to 4 mm, and/or that for minimum wall thicknesses (WS) of between 0.5 mm and 5 mm the change of the wall thickness follows the formula Y=X times WS, wherein X is selected from a range between 0.2 to 3, and for minimum wall thicknesses WS between 6 mm and 10 mm the change of wall thickness follows the formula Y=X times WS, wherein X is selected from a range of 0.2 to 10, which can also serve to achieve a reduction of the risk of the connecting element being torn off a ring element by improving the mechanical load capacity.

According to an embodiment variant of the device, the centering unit can comprise centering pins, with which the centering unit and thus the device can be designed relatively simply.

However, for the aforementioned reasons, according to another embodiment variant of the device the centering unit comprises centering arches or centering ring webs.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a gear in an exploded view;

FIG. 2 shows an embodiment variant of the second, radially outer ring element of the gear;

FIG. 3 shows a cutout from an embodiment variant of the gear;

FIG. 4 shows a cutout from a further embodiment variant of the gear;

FIG. 5 shows a cutout from another embodiment variant of the gear;

FIG. 6 shows a gear drive;

FIG. 7 shows a device for producing the gear; and

FIG. 8 shows a cutout from another embodiment variant of the gear.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

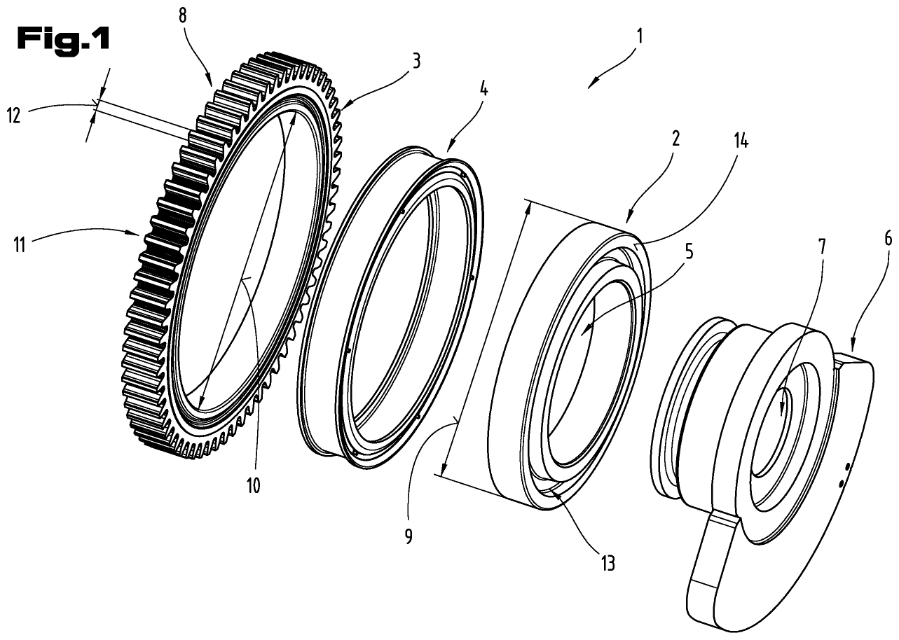

FIG. 1 shows a gear 1 in an exploded view. The gear 1 consists of a and/or comprises a first, radially inner ring element 2 (hereinafter referred to as first ring element 2), a second, radially outer ring element 3 (hereinafter referred to as second ring element 3) and a connecting element 4. The first ring element 2 can also be referred to as hub part and the second ring element 3 can also be referred to as gear rim.

The first ring element 2 and/or the second ring element 3 preferably consist of a metal material, for example a steel, preferably of a sintered material, for example a sintered steel. However, other metal materials can also be used for the first ring element 2 and/or the second ring element 3, wherein the first ring element 2 and/or the second ring element 3 can also consist of at least two different metal materials.

The connecting element 4 at least partially consists of a rubbery-elastic material, for example of an (X)NBR ((carboxylated) acrylonitrile butadiene rubber), HNBR (hydrogenated nitrile rubber), a silicone rubber (VMQ), NR (natural rubber), EPDM (ethylene propylene diene monomer rubber), CR (polychloroprene), SBR (styrene butadiene rubber) etc., wherein here again, mixtures of materials may be used.

“At least partially” means that for example stiffening elements, such as fibers and/or threads, for example of metal, plastic materials, natural fibers etc., or bars, etc. may be incorporated in the connecting element 4. However, the connecting element 4 preferably solely consists of a rubbery-elastic material.

The first ring element 2 comprises an axially extending recess 5, in particular a bore. Thereby, the first ring element 2 can be arranged on a not depicted shaft, or as can be seen in FIG. 1 on an unbalanced mass element 6 according to an embodiment variant. The unbalanced mass element 6, in turn, can have a recess 7, in particular a bore, for arrangement on a shaft.

Such unbalances are in particular used in balance shafts of combustion engines.

The second ring element 3 comprises a toothing 8 on the radially outer end face. The toothing 8 can have a shape adapted to the respective case of application of the gear 1, for example for the formation of a transmission gear. Furthermore, the toothing 8 can extend across the entire width of the second ring element 3 or just across a partial area of this width in the axial direction of the gear 1.

The connecting element 4 is arranged between the first ring element 2 and the second ring element 3. By means of this connecting element 4, the first ring element 2 and the second ring element 3 are connected to one another for forming the gear 1.

The second ring element 3 is arranged in the radial direction above the first ring element 2 and in particular concentrically to it. In this regard, it can be provided for that a deviation of the coaxiality of an outer diameter 9 of the first ring element 2 to an inner diameter 10 of the second ring element 3 amounts to a maximum of 0.8 mm, preferably a maximum of 0.5 mm, for example between 0.01 mm to 0.45 mm.

The toothing 8 comprises teeth 11 with a tooth thickness 12. The tooth thickness 12 is measured at half the height of the tooth flanks of the teeth 11, as shown in FIG. 1.

As an alternative to or in addition to the embodiment variant of the gear 1 described above with the mentioned coaxiality of the outer diameter 9 of the first ring element 2 to the inner diameter 10 of the second ring element 3, it can be provided for that the toothing 10 of the second ring element 3 is formed with teeth 11 having a different tooth thickness 12. Different tooth thicknesses can for example be realized by the displacement of the base circle of each individual tooth, wherein the engagement angle of the teeth 11 of the toothing 10 of the gear 1 into a toothing of a further gear can also be selectively adapted. This has the advantage that the tooth thickness measured at the tip circle remains the same, with the tooth thickness at the pitch circle decreasing.

The tooth thicknesses 12 of the teeth 11 can vary by 1% to 25% in the circumferential direction, relative to the thickest tooth 11 of toothing 10. The variation in the tooth thickness can be periodic or aperiodic.

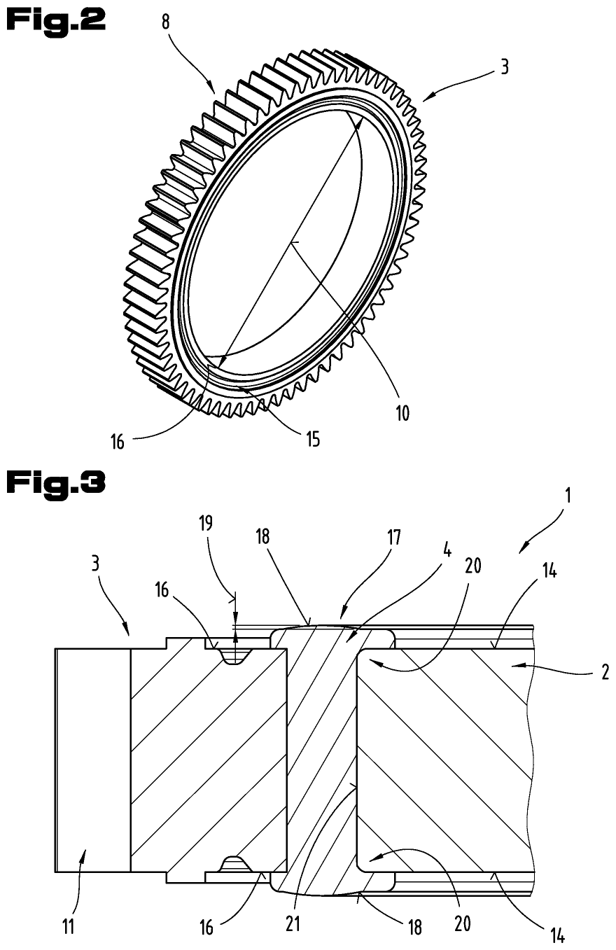

According to an embodiment variant of the gear 1, it can be provided for that the first ring element 2 is at least sectionally formed with a groove 13 in an end face 14 and the second ring element 3 is formed at least sectionally with at least one groove 15 in an end face 16, as can be seen from FIGS. 1 and 2. The groove 13 or the groove 15 or the groove 13 and the groove 15 are preferably designed as annular grooves. However, it is also possible that these are only formed in partial areas, for example as ring segments and/or arc-shaped. In this case, preferably sever ring segments, for example two, three, four, five, six, etc. are provided per end face 14, 16.

The groove 13 can in particular be arranged at a distance to the outer diameter 9 of the first ring element 2 which is selected from a range of 2 mm to 6 mm.

The groove 15 can in particular be arranged at a distance to the inner diameter 9 of the second ring element 3 which is selected from a range of 2 mm to 6 mm.

The grooves 13, 15 serve for centering the outer diameter 9 of the first ring element 2 with the inner diameter 10 of the second ring element 3, as will be explained below. Maintenance of the mentioned distances in particular improves the centering of the two ring elements 2, 3.

In FIGS. 3 to 5, further an optionally independent embodiment variants of the gear 1 are shown in extracts, wherein again, equal reference numbers and/or component designations are used for equal parts as for FIGS. 1 and 2 before. In order to avoid unnecessary repetitions, it is pointed to/reference is made to the detailed description regarding these FIGS. 1 and 2.

As can be seen from FIG. 3, according to an embodiment variant of the gear 1, it can be provided for that the connecting element 4 is formed to be planar on an outer surface or solely with at least one elevation 17. In any case, the connecting element 4 comprises no recess in the mentioned surface, i.e. the end face 18, in this embodiment variant.

Although just one elevation 17 is shown in FIG. 3, several elevations can be provided on the end face, for example two or three. In the radial direction of the gear 1, the elevations can be arranged on top of one another and optionally at a distance from one another.

The at least one elevation 17 can be formed in the shape of an annular web, as is shown in FIG. 3. However, other shapes of the elevation 17 can be arranged as well, for example knob-shaped.

Preferably, the at least one elevation 17 is or the elevations 17 are not arranged in the radial overlapping area of the connecting element 4 with the ring elements 2, 3.

A height of the elevation(s) 17 in the axial direction can be selected from a range of 0.5 mm to 3 mm.

The at least one elevation 17 can for example be formed in a bow-shaped cross-sectional shape, as is shown in FIG. 3. However, other shapes, such as trapezoid, rectangular, hexagonal and/or in general polygonal etc. shapes are also possible, in each case as viewed in the cross-section.

Preferably, with several elevations 17, all of them are formed equally, wherein, however, differently formed elevations 17 can be used as well.

It is preferred if on both sides at least one elevation 17 is formed, i.e. on both outer end faces 17 of the connecting element 4.

FIG. 3 shows a further embodiment variant of the gear 1. Therein, the first ring element 2 is provided with at least one first curvature 20 in the connection area between the first ring element 2 and the connecting element 4. Preferably, such curvatures 20 are formed on both sides, i.e. on both end faces 14 of the first ring element 2. It is further preferred if these curvatures 20 on both sides are formed equally, while there can be cases of application in which the two curvatures 20 of the first ring element 2 are not equal, i.e. for example have an unequal curvature radius and/or an unequal curvature width.

The curvatures 20 emerge by the edges in the transition areas of the end faces 14 to a lateral surface 21 of the first ring element 2 being rounded off. As an alternative to the curvatures 20, chamfers can be provided as well.

The radius of the curvature 20 amounts to at least 0.1 mm.

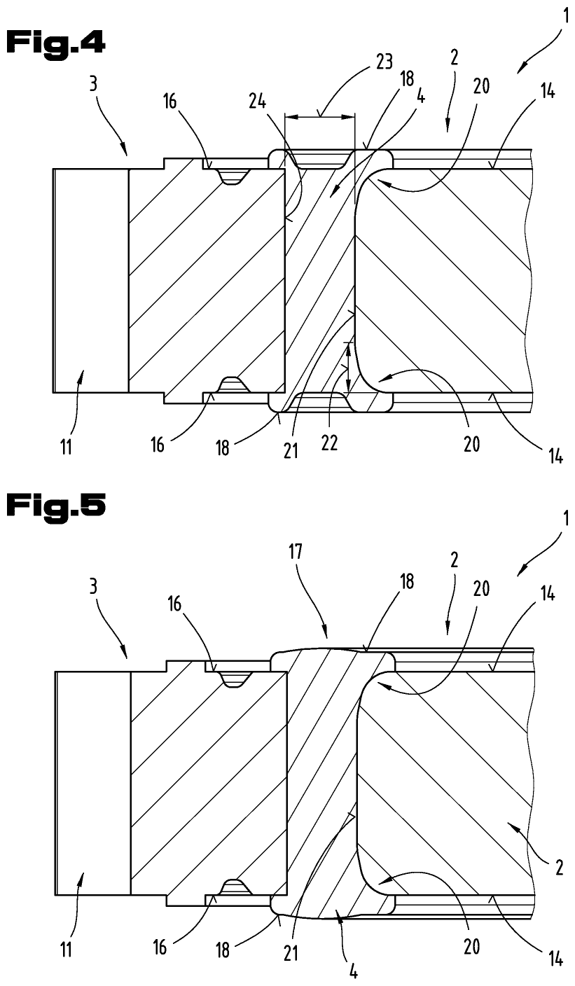

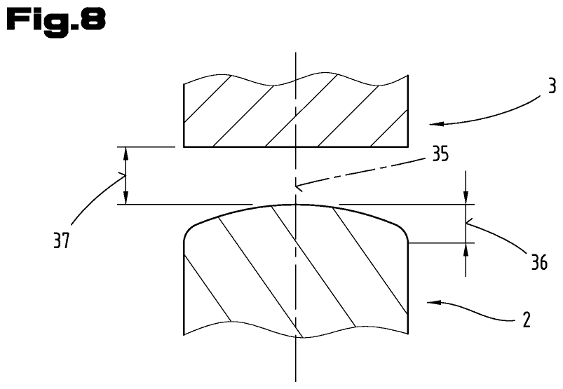

In the simplest case, the curvatures are designed as pitch circles, for example quarter circles. According to another embodiment variant of the gear 1 shown in FIG. 4, however, it can be provided for that the radius of the first curvature 20 differs across the extent in the axial direction. For example, the curvature 20 can have a radius extent that has a value between 0.1 mm and 5 mm at the beginning of the curvature 20 on the end face 14 of the first ring element 2. This curvature area can transition into an adjacent curvature area with a radius between 0.2 mm and 10 mm, before the curvature 20 tapers off into the lateral surface 21. However, other curvature extents are also possible. For example, behind the first curvature (from the outside to the inside) with a radius of 0.1 mm to 5 mm, just one further radius with the circular mid-point on a symmetry axis 35 of the connecting element 4 in the axial direction can follow, as is shown in FIG. 8. In this regard, a maximum height 36 of the curved area in the radial direction can amount to 0.2 times to 5 times the minimum radial wall thickness 37 (WS) of the connecting element 4.

In general, the first curvature 20 can have several radii, preferably between two and five different radii, wherein the size of the radii in the direction from the outside to the inside increases, meaning that the largest radius is formed in the region of the end face 14 of the first ring element 2 and the smallest one is formed on the transition into the even area of the first ring element 2.

According to a further embodiment variant of the invention, it can be provided for that the first radius of the first curvature of the first, radially inner ring element 2 amounts to at least 0.1 mm in the connection area between the first, radially inner ring element and the connecting element 4, that further the connecting element 4 in the radial direction has a wall thickness 37 (WS) (FIG. 8) of at least 0.5 mm in the area between the first, radially inner ring element 2 and the second, radially outer ring element 3. The wall thickness 37 can in particular be selected from a range of 0.5 mm to 10 mm, preferably be selected from a range of 3 mm to 4 mm.

In the alternative or in addition to this, it can be provided for that for minimum wall thicknesses 37 (WS) between 0.5 mm and 5 mm the change of the wall thickness 37 follows the formula Y=X times WS, wherein X is selected from a range of 0.2 to 3, and for minimum wall thicknesses WS between 6 mm and 10 mm the change of wall thickness follows the formula Y=X times WS, wherein X is selected from a range of 0.2 to 10. In this regard, the wall thickness of the curved area (i.e. the radial height 36 in FIG. 8) of the first ring element 2 increases from the outside to the inside).

According to a further embodiment variant of the gear 1 also shown in FIG. 4, it can be provided for that the curved area in the axial direction of the first ring element 2 has a width 22, which is selected from a range of 0.5% to 50%, in particular selected from a range of 1% to 30%, of the radial thickness 23 of the connecting element 4 between the first ring element 2 and the second ring element 3.

According to another embodiment variant of the gear 1, it can be provided for that the curved area in the axial direction of the first ring element 2 has a width 22, which is selected from a range of 0.1% to 10% of the axial length of the first ring element 2 or of the axial length of the second ring element 3.

As can be seen from FIG. 4, it is also possible that the connecting element 4 has a recess in at least one of the end faces 18.

According to a further embodiment variant of the gear 1 also shown in FIG. 4, the second ring element 3 can be formed to be sharp-edged in the connection area between the second ring element 3 and the connecting element 4. Thus, the edges between the end faces 16 and a radially inner lateral surface 24 of the second ring element 3 are not curved in this embodiment variant of the gear 1.

In the alternative to this, it can be provided for that the edges between the end faces 16 and the radially inner lateral surface 24 of the second ring element 3 also have curvatures, wherein these curvatures are, however, formed smaller than the first curvatures 20 described above. Smaller in this respect means that the axial width of these curvatures is smaller than the axial width 22 of the first curvatures 20 and/or that the curvature radius is smaller than the radius of the first curvatures 20. In particular, the radius of the curvatures of the second ring element 3 can be selected from a range of 0.01 mm to 0.1 mm.

The embodiment variant of the gear 1 shown in FIG. 5 is to illustrate that combinations of the different embodiment variant described above are also possible. In this regard, reference is made to the explanations above.

As can for example be seen from FIG. 3, the connecting element 4 can extend to project beyond the first ring element 2 and the second ring element 3 in the axial direction and to partially cover the first ring element 2 and/or the second ring element 3 in the radial direction. The connecting element 4 can thus in particular comprise an at least approximately H-shaped and/or an H-shaped cross-section.

However, it is also possible, although not preferred, that the connecting element 4 is designed to be flush with the axial end faces 14, of the first ring element 2 and/or flush with the axial end faces 16 of the second ring element 3.

It is also possible that the connecting element 4 only in the area of the axial end faces 14 of the first ring element 2 or only in the area of the axial end faces 16 of the second ring element 3 extends to protrude from these surfaces in the axial direction and to partially cover these in the radial direction.

Moreover, the radial coverage widths of the connecting element 4 can differ. For example, the coverage (overlapping) of the first ring element 2 by the connecting element 4 can be larger than that of the second ring element 3, as is shown in FIGS. 3 to 5. However, the reverse embodiment is also possible.

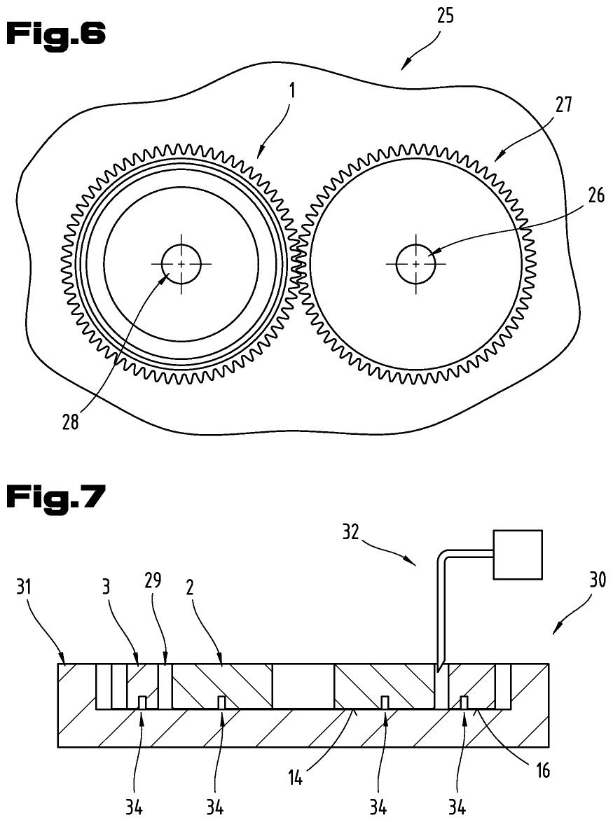

FIG. 6 shows a preferred application of the gear 1 in a gear drive 25. The gear drive 25 comprises a crankshaft 26 with a first gear 27, which is arranged in meshing engagement with a second gear, wherein the second gear is arranged on a mass balance shaft 28. The second gear is formed by the gear 1 according to the invention.

For producing the gear 1, it can be provided for that first the two ring elements 2, 3 are produced and provided. In particular, the two ring elements 2, 3 are produced powder-metallurgically according to a sintering method. These two ring elements 2, 3 are accordingly arranged such that the first ring element 2, as viewed in the radial direction, is arranged within the second ring element. Due to the size of the two ring elements (the inner diameter 10 of the second ring element 3 is larger than the outer diameter 9 of the first ring element 2), the first ring element 2 is arranged at a distance from the second ring element 3, such that an intermediate space 29 is formed between the two ring elements 2, 3, as can for example be seen from FIG. 7. In this intermediate space 29, the connecting element 4 (e.g. FIG. 1) is produced from a vulcanizable or polymerizable mass. For this purpose, the vulcanizable or polymerizable mass is filled into the intermediate space 29 and subsequently vulcanized or polymerized, for example at an increased temperature or by the effect of radiation, such as UV light. However, before the vulcanizable or polymerizable mass is filled into the intermediate space 29, the two ring elements 2, 3 are centered with respect to one another, meaning that in particular the inner diameter 10 of the second ring element 3 is centered with respect to the outer diameter 9 of the first ring element 2. For this purpose, the two ring elements 2, 3 comprise the aforementioned centering recesses in the end faces 14 and/or 16, i.e. for example the first ring element 2 comprises the groove 13 and the second ring element 3 comprises the groove 15. The centering can take place automatically by the centering recess engaging with a centering tool.

This process can for example be carried out in a device 30, as is shown in FIG. 7. However, the process can also be carried out by means of other devices.

The device 30 for producing the gear 1 comprises a mold 31 with a mold cavity for receiving the first ring element 2 and the second ring element 3 at a distance from the first ring element 2 forming the intermediate space 29. The device 30 further comprises at least one feed unit 32 for the vulcanizable or polymerizable mass for producing the connecting element 4. For the centering of the two ring elements 2, 3 addressed above, the device 30 comprises a centering unit 33, which in each case comprises at least one centering recess in the end face 14 of the first ring element 2 and an end face 16 of the second ring element 3 for centering the first ring element 2 and the second ring element 3 with respect to one another.

The centering unit 33 can have individual centering pins, which engage into correspondingly formed centering recesses in the end faces 14, 16 of the ring elements 2, 3, for example bores for centering pins with curved cross-sections. In this case, preferably at least three centering pins per ring element 2, 3 are provided in the centering unit 33.

According to another embodiment variant of the device 30 for producing the gear 1, the centering unit 33 comprises centering arches or centering webs 34, in particular ones formed arcuately. The centering webs can formed just sectionally as segments or preferably as annular webs.

The centering pins, the centering arches or the centering webs 34 form the centering elements of the centering unit 33. Other centering elements than those mentioned or a combination of different centering elements can also be provided in the centering unit 33.

The centering elements can for example be arranged on the bottom of the mold 31 as fixed elements. However, they can also be extendible and retractable in the vertical direction to the bottom such that they are only extended when the two ring elements 2, 3 have already been placed in the mold 31.

It can further be provided for that the centering elements have a conical shape or a shape with a tapering cross-section, for example a trapezoidal cross-section. In this regard, the tapering is directed towards the ring elements 2, 3 such that the centering elements can more easily be inserted into the centering recesses in the end faces 14, 16 of the ring elements 2, 3 and during further insertion of the centering elements into these centering recesses in the ring elements 2, 3 an automatic centering and lastly a fixation of the ring elements 2, 3 at the centered position takes place.

The exemplary embodiments show possible embodiment variants of the gear 1 and/or the gear drive 25 and/or the device 30 for producing the gear 1, while combinations of the individual embodiment variants are also possible.

Finally, as a matter of form, it should be noted that for ease of understanding of the structure of the gear 1 and/or the gear drive 25 and/or the device 30 for producing the gear 1, these are not obligatorily depicted to scale.

Although only a few embodiments of the present invention have been shown and described, it is to be understood that many changes and modifications may be made thereunto without departing from the spirit and scope of the invention.

### LIST OF REFERENCE NUMBERS

1 gear
2 ring element
3 ring element
4 connecting element
5 recess
6 unbalanced mass element
7 recess
8 toothing
9 outer diameter
10 inner diameter
11 tooth
12 tooth thickness
13 groove
14 end face
15 groove
16 end face
17 elevation
18 end face
19 height
20 curvature
21 lateral surface
22 width
23 thickness
24 lateral surface
25 gear drive
26 crankshaft
27 gear
28 mass balance shaft
29 intermediate space
30 device
31 mold
32 feed unit
33 centering unit
34 centering web
35 symmetry axis
36 height
37 wall thickness

1. A gear (1) comprising a first, radially inner ring element (2), a second, radially outer ring element (3) and a connecting element (4), wherein the second, radially outer ring element (2) comprises a toothing (8), wherein further the connecting element (4) is arranged in the radial direction between the first, radially inner ring element (2) and the second, radially outer ring element (3) and is connected to the first, radially inner ring element (2) and the second, radially outer ring element (3), and wherein the connecting element (4) is made at least partly from a rubbery-elastic material, wherein a deviation of the coaxiality of the outer diameter (9) of the first, radially inner ring element (2) to the inner diameter (10) of the second, radially outer ring element (3) amounts to a maximum of 0.8 mm and/or the toothing (8) of the radially outer ring element (3) is formed with teeth (11) having different tooth thicknesses (12).

2. The gear (1) according to claim 1, wherein both the first, radially inner ring element (2) and the second, radially outer ring element (3) are at least sectionally formed with at least one groove (13, 15) in an end face (14, 26).

3. The gear (1) according to claim 1, wherein the connecting element (4) is formed to be planar on an outer surface or solely with at least one elevation (18) and without any recesses.

4. The gear (1) according to claim 1, wherein the first, radially inner ring element (2) is provided with at least one first curvature (20) in the connection area between the first, radially inner ring element (2) and the connecting element (4).

5. The gear (1) according to claim 4, wherein the curved area in the axial direction of the first, radially inner ring element (2) has a width (22) selected from a range of 0.5% to 50% of the radial thickness (23) of the connecting element between the first, radially inner ring element (2) and the second, radially outer ring element (3).

6. The gear (1) according to claim 4, wherein the radius of the first curvature (20) differs across the extent in the axial direction.

7. The gear (1) according to claim 6, wherein the first curvature (20) has several radii, preferably between two and five different radii, with a size increasing as seen from the outside towards the inside.

8. The gear (1) according to claim 4, wherein the second, radially outer ring element (3) is provided with at least one second curvature in the connection area between the second, radially outer ring element (3) and the connecting element (4), wherein the second curvature is smaller than the first curvature (20).

9. The gear (1) according to claim 4, wherein the second, radially outer ring element (3) is formed to be sharp-edged in the connection area between the second, radially outer ring element (3) and the connecting element (4).

10. The gear (1) according to claim 4, wherein the first radius of the first curvature (20) of the first, radially inner ring element (2) in the connection area between the first, radially inner ring element (2) and the connecting element (4) amounts to at least 0.1 mm, wherein further the connecting element (4) in the area between the first, radially inner ring element (2) and the second, radially outer ring element (3) has a wall thickness WS (37) in the radial direction of at least 0.5 mm and wherein for minimum wall thicknesses (WS) of between 0.5 mm and 5 mm the change of the wall thickness follows the formula Y=X times WS, wherein X is selected from a range between 0.2 to 3, and for minimum wall thicknesses WS between 6 mm and 10 mm the change of wall thickness follows the formula Y=X times WS, wherein X is selected from a range of 0.2 to 10.

11. A gear drive (25) comprising a crankshaft (26) with a first gear (27), which is arranged in meshing engagement with a second gear, wherein the second gear is arranged on a mass balance shaft (28), wherein the second gear is designed as gear (1) according to claim 1.

12. A method for producing a gear (1) comprising the steps:
providing a first, radially inner ring element (2),
providing a second, radially outer ring element (3),
arranging the first, radially inner ring element (2) at a distance from the second, radially outer ring element (3) forming an intermediate space (29),
producing a connecting element (4) between the first, radially inner ring element (2) and the second, radially outer ring element (2) by providing a vulcanizable or polymerizable mass in the intermediate space,
wherein
the first, radially inner ring element (2) and the second, radially outer ring element (3) are each formed with at least one recess in an end face (14, 16) and wherein the first, radially inner ring element (2) and the second, radially outer ring element (3) are centered by means of a centering tool which engages in the recesses before the vulcanizable or polymerizable mass is filled into the intermediate space (29).

13. A device (30) for producing a gear (1) comprising a first, radially inner ring element (2), a second, radially outer ring element (3) and a connecting element (4), wherein the connecting element (4) is arranged in the radial direction between the first, radially inner ring element (2) and the second, radially outer ring element (3) and is connected to the first, radially inner ring element (2) and the second, radially outer ring element (3), and wherein the connecting element (4) is made at least partly from a rubbery-elastic material, having a mold (31) with a mold cavity for receiving the first, radially inner ring element (2) and the second, radially outer ring element (3) at a distance from the first, radially inner ring element (2) forming an intermediate space (29), and having at least one feed unit (32) for a vulcanizable or polymerizable mass for producing the connecting element (4), wherein the device (30) further comprises a centering unit (33), which respectively engages in at least one recess in an end face (14) of the first, radially inner ring element (2) and in an end face (16) of the second, radially outer ring element (3) for centering the first, radially inner ring element (2) and the second, radially outer ring element (3) with respect to one another.

14. The device (30) according to claim 13, wherein the centering unit (33) comprises centering pins.

15. The device (30) according to claim 13, wherein the centering unit (33) comprises centering arches or centering webs (34).
